(19) United States
(12) Patent Application Publication
(10) Pub. No.: US 2008/0218369 A1
(43) Pub. Date: Sep. 11, 2008

(54) Flexible Display Device

(75) Inventors: Martijn Krans, Eindhoven (NL); Murray Fulton Gillies, Eindhoven (NL); Edzer Huitema, Eindhoven (NL); Sima Asvadi, Eindhoven (NL); Albert Hendrik Jan Immink, Eindhoven (NL); Johannes Theodorus Adriaan Wilderbeek, Eindhoven (NL); Alexander Ulrich Douglas, Eindhoven (NL); Jacqueline Van Driel, Drachten (NL); Eduard Josephus Hultermans, Turnhout (BE); Michel Paul Barbara Van Bruggen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,463

(22) PCT Filed: May 22, 2006
(86) PCT No.: PCT/IB06/51630

§ 371 Date: Nov. 26, 2007

(30) Foreign Application Priority Data
May 31, 2005 (EP) 05104675.3
Aug. 31, 2005 (EP) 05107967.1

(51) Int. Cl. G08B 5/00; H01J 1/62; H01J 9/24

(52) U.S. Cl. 340/691.1; 313/511; 445/24; 340/815.4

(57) ABSTRACT

The present invention relates to a flexible display device (10) comprising a flexible substrate (12), and a plurality of electro-optical switching elements (14) accommodated on the substrate. The device is characterized in that the substrate has a plurality of through openings (16) being arranged in a repetitive pattern so that the electro-optical switching elements are located in areas of the substrate adjacent to the openings. The through openings allow for bending the display device in two directions simultaneously, with reduced tensile or compressive stress in the plane of the substrate.

The present invention relates to a flexible display device comprising a flexible substrate accommodating a plurality of electro-optical switching elements. The present invention also relates to a method for the manufacture of such a flexible display device.

There is currently an emerging market for flexible display devices. Typically, thin bendable substrates made from plastics have been utilized to provide the mechanical flexibility to such display devices. An example of a flexible display device is disclosed in the document US2004124763. The display device comprises a flexible substrate and a plurality of pixels arranged in a form of rows and columns on the surface of the substrate. In order to increase the flexibility of the display, there is provided a plurality of parallel grooves in the surface of the substrate, where each groove is formed in between adjacent two rows or columns of the display pixels. Except providing flexibility, the grooves serve to decrease the propagation of mechanical stress caused when the display device is bent or rolled. However, a drawback with the flexible display device disclosed in US2004124763 is that it is only flexible in one dimension due to the layout and nature of the grooves. Other known flexible display devices also exhibit similar drawbacks. For example a flexible display device where two flexible plastic substrates are used with the pixels or electro-optical switching elements in between, buckling can occur when the display is bent in two dimensions at the same time, which in turn can cause local defects in the display. In other words, these display devices are rollable rather then flexible in a more general sense.

It is an object of the present invention to overcome this problem, and to provide an improved flexible display device, which can be bent in more than one direction at a time.

This and other objects that will be evident from the following description are achieved by means of a flexible display device, and a method for the manufacture of such a flexible display device, according to the appended claims.

According to an aspect of the invention, there is provided a flexible display device comprising a flexible substrate, and a plurality of electro-optical switching elements accommodated on the substrate, whereby the substrate has a plurality of through openings being arranged in a repetitive pattern so that the electro-optical switching elements are located in areas of the substrate adjacent to the openings. Preferably, the openings are arranged in a grid pattern, i.e. in a network of uniformly spaced horizontal and perpendicular lines.

The through openings allow for bending the display device in two directions simultaneously, with reduced tensile or compressive stress in the plane of the substrate.

Preferably, at least one opening has essentially equal extension in two perpendicular directions in the plane of the substrate, forming two main extensions. Further, the at least one opening preferably has a smaller extension compared to the main extension in a direction between said two perpendicular directions. The opening can for example be formed like a cross.

Preferably, the openings are uniformly aligned, i.e. all openings are in the oriented in the same direction. Further, each opening is preferably so arranged that its two main extensions are aligned with the grid pattern. For example, the direction of the first main extension can be parallel to the horizontal lines of the grid pattern and the second main extension can be parallel to the perpendicular lines of the grid pattern. This allows for increased flexibility of the display device.

The openings can define a plurality of first areas of the substrate, each of which can accommodate at least one electro-optical switching element or part of a electro-optical switching element, and a plurality of second areas having no electro-optical switching element(s), which second areas connect adjacent first areas. Here, the bending action is concentrated to the second connection areas. Thus, a bending moment of the display device will cause a bending moment mainly along connection areas rather than through a first switching element area. The longer connection areas, the more flexible display device. Further, conducting lines for electrically connecting the electro-optical switching elements can be guided via the second areas.

A stiffening plate can further be attached at each first area, whereby the size of the stiffening plate essentially corresponding to the size of the first area. The stiffening plates can for example be placed on the opposite side of the substrate in relation to the electro-optical switching elements, so that the plats do not disrupt any emission of light from the switching elements. The stiffening plates make it possible to provide a very flexible display device even if the electro-optical switching elements themselves are not flexible. The bending action of the substrate is concentrated to the connections areas connection each first area accommodating electro-optical switching element(s).

The substrate of the flexible display device can be made of plastic sheets, such as thin film plastic sheets. Further, the electro-optical switching elements of the flexible display device according to the invention can be individually addressed. In this case, the electro-optical switching elements can be pixels and the flexible display device can be used as a display. As an alternative, the flexible display device according to the invention can be used as a light source. In this case, the electro-optical switching elements can for instance be constituted by light emitting diodes (LEDs).

The substrate and the electro-optical switching elements of the flexible display device can further be encapsulated by an encapsulation, preferably of an elastomer material, so that the substrate and electro-optical switching elements are completely surrounded by the elastomer material. This protects the substrate and electro-optical switching elements, and enhances the mechanical properties of the display device.

Further, the flexible display device can comprise, in particular when used as an emissive display or (LED) light source, a flexible diffusing element being arranged to receive and diffuse light from the electro-optical switching elements. For example inorganic LEDs are small point sources of light, and multiple LEDs distributed over the surface of a substrate will not allow the entire substrate to emit light, but just the small fraction of the substrate covered with the source. By applying a diffuser, a more uniform out-coupling of light from the substrate surface can be obtained. The diffuser is especially advantageous when the electro-optical switching elements are spaced apart by long flexible connecting area. The diffuser is also advantageous when inorganic LEDs are used, where each LED is surrounded by a conductive area to spread the heat generated by the LED.

Preferably, the diffusing element comprises at least one layer of fabric, and more preferably, the diffusing element comprises at least one layer of non-woven fabric. Non-woven is produced from fibrous web bonded by mechanical entanglement of the fibers or by use of resins, thermal fusion and formation of chemical complexes. The fibers in the web can be arranged in a random or oriented fashion. Thus, a non-woven material in essence is a mixture of air and random fibers. Therefore, it contains the two essential elements for diffusion: air and randomness of the fibrous material. Also, it is very flexible, making it especially suitable for an emissive display device with enhanced flexibility.

The density of the non-woven fabric may be lower at a face of the diffusing element facing an electro-optical switching element compared to the density at a face of the diffusing element opposite to the electro-optical switching element. For example, the diffusing element may comprise a first layer of non-woven fabric arranged adjacent to the electro-optical switching elements and a second layer of non-woven fabric arranged on the first layer, where the density of the second layer is higher the density of the first layer.

The portion of the diffusing element being located close to the electro-optical switching elements has a low density, and thus provides a spacing between the electro-optical switching elements and the more dense portion of the diffusing element. In this spacing, the cone of light from or emitted by the electro-optical switching elements may expand, before encountering the more dense portion of the diffusing element, where the major part of the light diffusion occurs. The low-density portion also helps keeping the space between the electro-optical switching elements and the denser portion acceptably constant, even if the display device is bended, etc. The denser portion of the diffusing element is to diffuse the light and hence provide homogeneity to the light-containing surface.

As alternative to the non-woven fabric-diffusing element, the diffusing element can for example comprise a foam, a woven fabric, or any other suitable material(s).

The display device can further comprise an elastomer layer disposed between the substrate and the diffusing element, for increasing the homogeneity of the display device.

The display device can further comprise an outermost layer comprising at least one cover layer of whitish fabric. The whitish fabric cover layer(s) can for instance be placed on top of the diffusing element. The fabric can for example be woven or knitted to give the device a traditional fabric feel. Preferably, the cover layer is white or whitish to avoid color filtering.

The outermost layer can further comprises at least one cover layer of colored open structure fabric on top of the whitish fabric cover layer(s). Alternatively, the outermost layer comprises the at least one cover layer of colored open structure fabric only. The colored open structure fabric cover layer(s) can for example be a fishnet or lace type fabric. The colored open structure fabric cover layer(s) acts as a contrast enhancing ant-reflective coating on the display device, and it allows the display to have any color in the off state, without acting as a color filter in the on-state (due to the open structure).

The flexible display device can further comprise driver electronics for driving the electro-optical switching elements, wherein the driver electronics are positioned separated from the flexible substrate. Thus, the driver electronics are not positioned on the flexible substrate. This can enhance the flexibility of the display substrate compared to a display where the driver electronics are positioned on the flexible substrate, since large diver electronics components cannot be bent over large angles without being damaged. Preferably, the driver electronics are positioned on a rigid substrate separated from the flexible substrate.

According to another aspect of the present invention, there is provided a method for the manufacture of a flexible display device, which method comprises providing a flexible substrate, providing a plurality of electro-optical switching elements on the substrate, and providing a plurality of through openings in the substrate, which openings are arranged in a repetitive pattern so that the electro-optical switching elements are located in areas of the substrate adjacent to the openings. This method offers similar advantages as obtained with the previously discussed aspect of the invention.

The through openings can be achieved by punching by means of a punch. Also, the substrate can comprise an upper and lower plastic sheet, with the electro-optical switching elements positioned between the sheets, whereby the punch during a punching operation can be heated to at least the melting temperature of the sheets, for creating a seal between the sheets at the openings. Hermetical sealing of the optically active area, i.e. the electro-optical switching element, is required in many types of display devices, for example displays based on polymer light emitting devices.

According to yet another aspect of the present invention, there is provided a textile product comprising a flexible display device.

These and other aspects of the present invention will now be described in more detail; with reference to the appended drawings showing currently preferred embodiments of the invention.

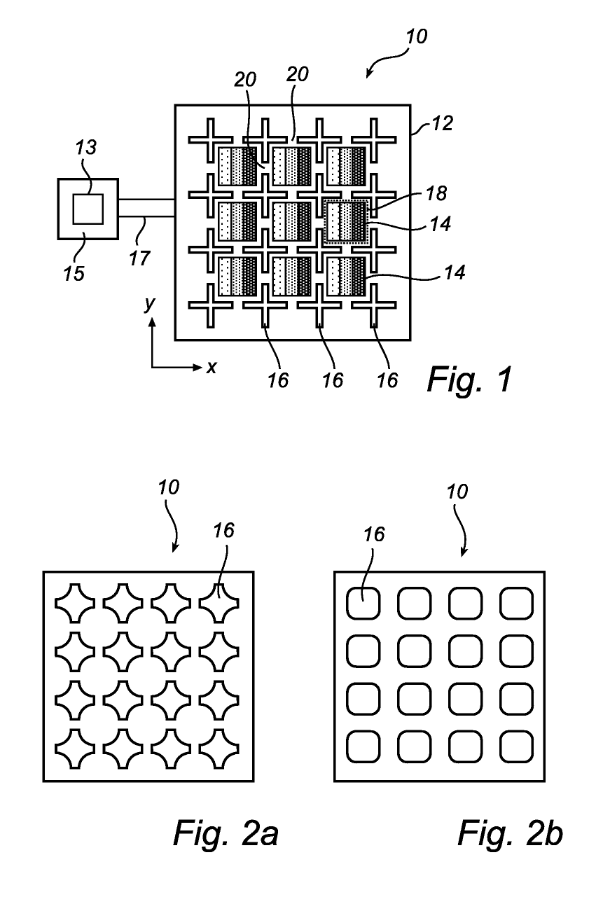

FIG. 1 is a top view of a flexible display device according to an embodiment of the present invention,

FIGS. 2a-2b are top views illustrating alternative shapes of the openings of a flexible display device according to the invention,

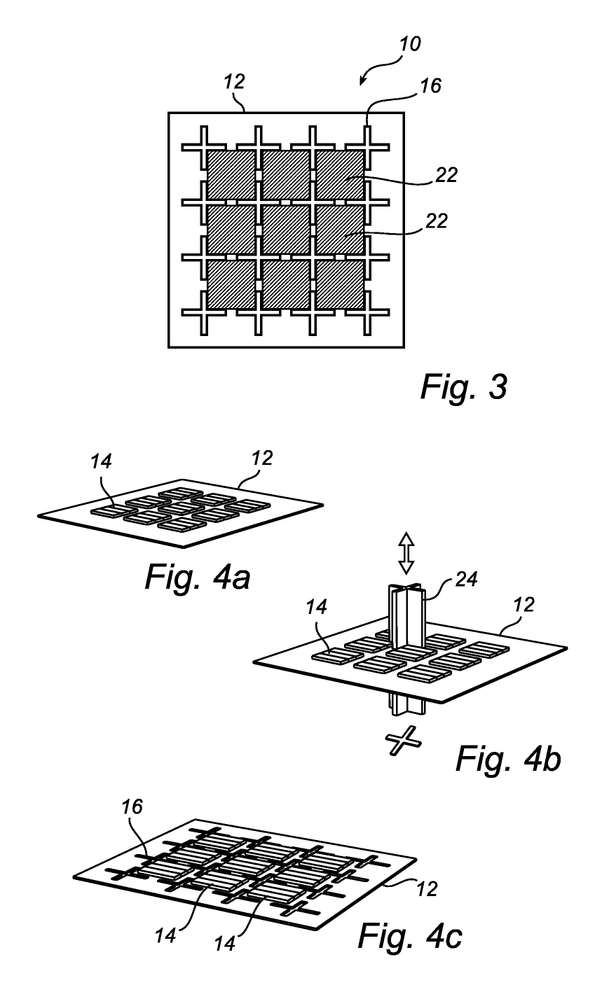

FIG. 3 is a bottom view of a flexible display device according to another embodiment of the present invention,

FIGS. 4a-4c are perspective views illustrating a method for the manufacture of a flexible display device,

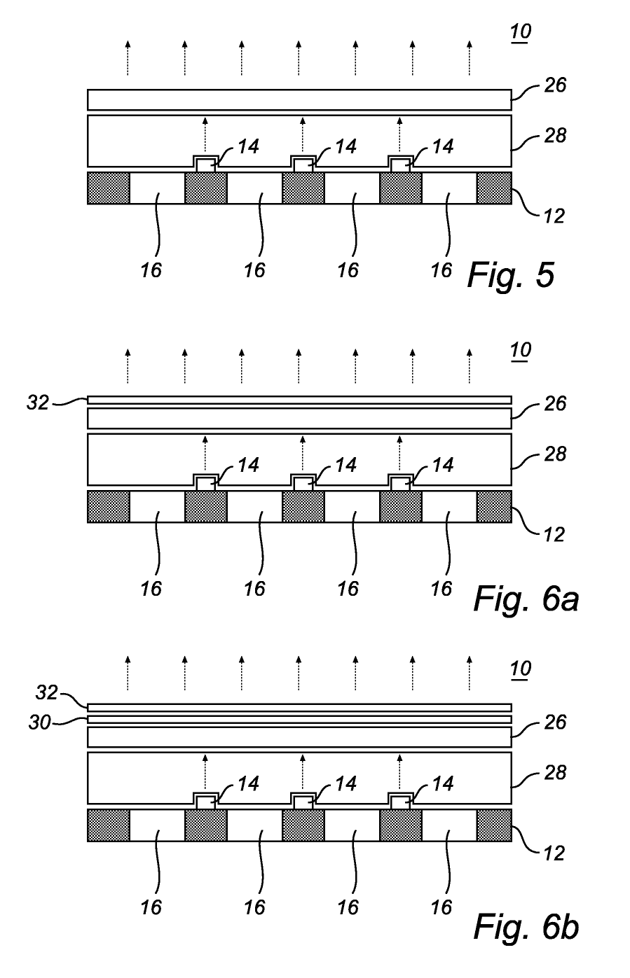

FIG. 5 is a side view of a flexible display device including a diffuser according to an embodiment of the present invention, and

FIGS. 6a-6b are side views of a flexible display device including a colored open structure fabric cover according to embodiments of the present invention.

FIG. 1 is a top view of a flexible display device 10 according to an embodiment of the present invention. The display device can for example be a display for displaying messages, images, etc., or a light source. The flexible display device 10 comprises a substrate 12 made of a flexible material. The substrate 12 can for example comprise thin plastic sheets. The substrate 12 further accommodates a plurality of electro-optical switching elements 14. The electro-optical switching element can for example be transmissive, reflective or emissive. An emissive electro-optical switching element can for example be one or more light emitting diodes (LEDs). The electro-optical switching elements 14 are driven by drive electronics 13 positioned on a rigid substrate 15 separated from the flexible substrate 12. Electrical connection 17 connects the driver electronics 13 to the electro-optical switching elements 14 via conducting lines (not shown) in/on the substrate. Alternatively, the drive electronics could be positioned on the flexible substrate.

Further, there is provided a plurality of through openings 16 in the substrate 12. In this embodiment, the openings 16 are cross-shaped. The openings 16 are arranged in a repetitive pattern across the substrate 12. Here, the openings 16 are arranged in a grid pattern, i.e. in a network of uniformly spaced horizontal and perpendicular lines, which is aligned to the edges of the substrate 12. Each opening 16 has equal extension in two perpendicular directions (namely the x and y directions) in the plane of the substrate 12, and a smaller extension in a direction between said two perpendicular directions, as can be seen in FIG. 1. Also, the openings 16 in FIG. 1 are all equally sized and oriented in the same direction, i.e. uniformly aligned. Further, the openings 16 are aligned with the grid pattern, i.e. the direction of the first main extension (x) is parallel to the horizontal lines of the grid pattern and the second main extension (y) is parallel to the perpendicular lines of the grid pattern.

The shape and layout of the openings 16 results in that an array of (first) areas 18 are formed, which areas 18 accommodate the electro-optical switching elements 14 of the display. In FIG. 1, one pixel 14 is accommodated in each area 18, which pixel is made from a red light emitting element, a green light emitting element and a blue light-emitting element. However, it is also possible to place several pixels or sub-pixels in each area 18. Preferably, each area 18 corresponds to an integer amount of pixels or sub-pixels, or, in the case of sub-pixels, each pixel contains an integer amount of openings/patterns.

The areas 18 are connected to each other by (second) areas 20 of the substrate 12. These connection areas 20 preferably contain no electro-optical switching elements. In FIG. 1, each area 18, except areas at the edge of the substrate 12, is connected to adjacent areas 18 accommodating electro-optical switching elements by four connection areas or arms 20. Any conducting lines (not shown) electrically connecting the electro-optical switching elements 14, which conducting lines enable powering and/or addressing of the electro-optical switching elements, should preferably be guided via the connection areas 20.

As mentioned above, the openings 16 provide for increased flexibility of the substrate 12 and the display device 10. In particular, the display device 10 can be bent in two directions at the same time without being damaged. The bending and torsion action will be concentrated to the connection areas 20.

Optionally, both sides of the flexible display device 10 can be coated with a flexible and waterproof material (not shown), such as silicone rubber, polyurethane rubber or certain kinds of epoxy. This results in that the flexible display device becomes resistant to wear and tear, moisture and contamination, while it keeps its flexible character. Furthermore, the cover coating minimizes the mechanical stress in the flexible display device during bending, and protects it from excessive bending. The coating can either be fully transparent or diffusive.

FIGS. 2a and 2b illustrate alternative exemplary shapes of the through openings 16. In FIG. 2a, each opening 16 is formed like a plaquette, defining almost circular areas for accommodating electro-optical switching elements. In FIG. 2b, each opening 16 is formed like a square with rounded corners. As above, each through opening in FIGS. 2a and 2b has equal extension in two perpendicular directions in the plane of the substrate 12, and a smaller extension in a direction between said two perpendicular directions, resulting in improved flexibility characteristics for the substrate 12 and display device 10.

FIG. 3 is a bottom view of a flexible display device according to another embodiment of the present invention. The flexible display device in FIG. 3 is similar to the flexible display device in FIG. 1, except for the addition of local stiffening plates 22. Here, the stiffening plates 22 are attached on the opposite side of the substrate 12 in relation to the electro-optical switching elements 14. That is, the plates 22 are positioned so that they do not obstruct any light emitted or reflected from the optically active area of the electro-optical switching elements 14. The size of each plate 22 essentially corresponds to the size of the above-mentioned first area 18, as can be seen in FIG. 3.

In this embodiment, the flexing action of the substrate 12 and the display device 10 is concentrated to the connecting areas 20 between the areas 18. The plates 22 are advantageously used in combination with non-flexible electro-optical switching elements, serving as a support to the elements, whereby a flexible display device can be created regardless of the non-flexible elements. Due to the nature of the openings 16, the display device can be bent in two directions at the same time without being damaged.

A method for the manufacture of a flexible display device will now be described in relation to FIGS. 4a-4c. The through openings are preferably created as one of the last steps in the method for the manufacturing of the flexible display device. Therefore, in FIG. 4a, a substrate 12 comprising electro-optical switching elements 14, conducting lines (not shown), etc., is provided. The substrate 12 preferably comprises thin plastic sheets.

In the next step (FIG. 4b), a punch 24 is used to create the through openings in the substrate 12 by punching. The punch 24 has a cross section that corresponds to the desired shape of the through openings to be punched. The punch 24 in FIG. 4b is adapted to create one through opening per punching operation. In this case, the punching operation has to be repeated several times for each display device. Alternatively, a punch adapted to create several through openings in one punching operation can be used. In this case, a plurality of through openings or even all through openings can be created in one single punching operation.

The final flexible display device 10 comprising a plurality of through openings 16 is shown in FIG. 4c.

Optionally, during the punching operation (FIG. 4b), by heating the punch mould 24 above the melting temperature of an upper and lower sheet of the substrate 12, such as the top and bottom sheet, each electro-optical switching element can be hermetically sealed by locally melting together these sheets at the openings 14. This under the condition that the electro-optical switching element is covered on each side by at least one substrate plastic sheet.

As shown in FIG. 5, the flexible display device 10 can further comprise a diffuser 26 arranged to receive and diffuse light emitted by the electro-optical switching elements 14. The diffuser can advantageously be used when the display device is a light emitting display device. The diffuser is particularly useful when the flexible display device 10 is a pixilated light source and the electro-optical switching elements 14 are constituted by LEDs. By applying a diffuser 26, a more uniform out-coupling of light from the substrate surface can be obtained.

Here, the diffuser 26 comprises at least one layer of non-woven fabric. As mentioned above, such a non-woven fabric diffuser exhibits good diffusing characteristics and is especially suitable for flexible display devices, as the diffuser is made of flexible materials. Preferably, the light diffuser 26 comprises a first layer of a low-density non-woven fabric facing the electro-optical switching elements 14, and a second layer of a non-woven fabric whose density is higher than that for the first layer. As alternative to the non-woven fabric diffuser, the diffuser can for example comprise a foam, a woven fabric, or any other suitable material(s).

Optionally, a separate elastomer layer 28 can be disposed between the substrate 12 accommodating the electro-optical switching elements 14 and the diffuser 26. Since the electro-optical switching elements 14 may have a certain height, the flexible elastomer layer 28 has openings or holes at the locations of the electro-optical switching elements 14. Incorporating such a elastomer layer 28 gives the display device a more uniform feel, for example when being touched. Alternatively, the flexible substrate 12 and the electro-optical switching elements 14 can be completely surrounded by a coating (not shown), as described in relation to FIG. 1 above. The coating can be of an elastomer material. The coating can be achieved for example by immersion.

FIGS. 6a-6b are side views of a flexible display device 10 comprising an outermost layer including at least one cover layer of colored open structure fabric 32 according to embodiments of the present invention. The colored open structure fabric cover layer(s) 32 can for example be a fishnet or lace type fabric. The colored open structure fabric cover layer(s) acts as a contrast enhancing anti-reflective coating on the display device, and it allows the display to have any color in the off state, without acting as a color filter in the on-state (due to the open structure). In FIG. 6a, the colored open structure fabric cover layer(s) 32 is positioned on top of the diffuser 26. In FIG. 6b, the colored open structure fabric cover layer(s) 32 is positioned on top of at least one cover layer of whitish fabric 30, which whitish fabric cover layer(s) in turn is positioned on top of the diffuser 26. The whitish fabric can for example be woven or knitted to give the device a traditional fabric feel. It should be noted that in absence of a diffuser, the whitish fabric cover layer and/or the colored open structure fabric cover layer(s) can be positioned on top of for example the elastomer layer 28.

Areas of application for flexible display devices, in particular flexible display devices according to the present invention, includes, but is not restricted to: pillows, toys such as cuddly toys, mats or carpets, table cloths, garments such as gloves, curtains, furnishing fabrics, vehicle ceilings, bed textiles, and backpacks. Incorporating a flexible display device in such a textile product allows the textile product to become luminous and/or display messages.

For example, the flexible display device can be incorporated in a pillow. The pillow can also comprise communication means for receiving data, and means for controlling the output of the display device of the pillow according to the received data. The communication means can for example comprise a GSM-module, whereby a user from a mobile phone can send instructions of when and how to illuminate the pillow and/or send messages, such as SMS messages or MMS messages, to be displayed on the pillow. The communication means can alternatively comprise a Bluetooth module, whereby a user from a nearby Bluetooth device such as a computer can send instructions of when and how to illuminate the pillow, and/or send images or messages, such as e-mail messages, to be displayed on the pillow. Alternatively, the nearby Bluetooth device can be used to relay instructions, images, messages, etc. from a remote device to the pillow. The pillow can further or as an alternative comprise pressure sensor means for detecting pressure on the pillow, which sensor is connected to the control means to allow for touch sensitivity functionality. The flexible display device can in a similar manner be implemented in a (cuddly) toy.

Other communication technologies that can be used for communication with the textile product include, but is not limited to, UMTS, NFC, RFID, WiFi, wired communication, etc.

Also, the communication means can be used for direct communication between two textile products. For example, when an input is detected by the pressure sensor means (or any other suitable input means) of a first pillow, the communication means of that first pillow can send data to a second pillow, which data includes instructions of how to control the output of the display device of the second pillow. In this way, two-way communication between two pillows can be achieved.

In another example, the flexible display device can be incorporated in a floor mat or carpet or tablecloth. The mat can also comprise pressure sensor means for detecting pressure on the mat, and means for controlling the output of the display device of the mat according to the detected pressure, to allow for touch sensitivity functionality. For instance, a person standing on or touching a particular area of the mat can incur a certain corresponding illumination of the display device of the mat, for example an illumination of that particular area. Such a mat can for example be used in gaming, exercising, measuring weight, etc.

In yet another example, the flexible display device can be incorporated in a garment, such as a glove or a jacket sleeve, with the display device connected to a compass. The compass is adapted to detect the current bearing, and the glove can further comprise means for controlling the output of the display device of the glove according to the detected bearing. The detected bearing can be indicated by a message displayed on the display device and/or by a certain illumination of the display device of the glove. For example each direction can be indicated with a separate color or pattern. This allows for determination of the direction that is being pointed at. The glove could in addition be connected to a GPS (global positioning system) receiver in order to guide the wearer of the clothing in a desired direction.

In still another example, the flexible display device can be incorporated in a bag or a backpack, which also can include an audio system, or which is connectable to an audio system. Here, the display device can be linked to the audio system, and displaying for example audio equalizer signals, ambient patterns, song content descriptions, stand-alone images, icons for safety or self-expression or communication, etc. Preferably, the display device is overlaid by a semi-transparent fabric (for example thin fabric or mesh fabric) allowing the light emerging from the display device to be seen by a viewer.

The person skilled in the art realizes that the present invention by no means is limited to the preferred embodiments described above. On the contrary, many modifications and variations are possible within the scope of the appended claims. For example, through openings having different shapes could be provided on a single substrate. Also, the openings could occupy a larger area of the substrate than what is shown in the above figures, i.e. there could be more and/or larger openings provided in the substrate. Further, in case two unstructured parallel plate electrodes are used to address the pixels of the display device, the pattern of the through openings and the pixel patters could be different from each other. Further, even though the figures of the above description show a 3×3 pixel flexible display device, the flexible display device according to the invention can accommodate a much larger amount of pixels.

1-35. (canceled)

36. A flexible display device (10) comprising:
a flexible substrate (12), and
a plurality of electro-optical switching elements (14) accommodated on said substrate,
characterized in that
said substrate has a plurality of through openings (16) being arranged in a repetitive pattern so that said electro-optical switching elements are located in areas of the substrate adjacent to said openings.

37. A flexible display device according to claim 36, wherein said openings are arranged in a grid pattern.

38. A flexible display device according to claim 36, wherein at least one opening has essentially equal extension in two perpendicular directions in the plane of the substrate, forming two main extensions.

39. A flexible display device according to claim 38, wherein the at least one opening has a smaller extension compared to said main extension in a direction between said two perpendicular directions.

40. A flexible display device according to claim 36, wherein said openings are uniformly aligned.

41. A flexible display device according to claim 38, wherein each openings is so arranged that its two main extensions are aligned with said pattern.

42. A flexible display device according to claim 36, wherein said openings define:
a plurality of first areas (18) of said substrate, each first area being adapted to accommodate at least one electro-optical switching element or part of a electro-optical switching element, and
a plurality of second areas (20) having no electro-optical switching element(s), which second areas connect adjacent first areas.

43. A flexible display device according to claim 42, further comprising a plurality of conducting lines for electrically connecting the electro-optical switching elements, said conducting lines being guided via said second areas.

44. A flexible display device according to claim 42, wherein a stiffening plate (22) is attached at each first area, the size of the stiffening plate essentially corresponding to the size of the first area.

45. A flexible display device according to claim 36, wherein said substrate comprises plastic sheets.

46. A flexible display device according to claim 36, wherein said electro-optical switching elements are individually addressable.

47. A flexible display device according to claim 36, further comprising a flexible a diffusing element (26) being arranged to receive and diffuse light from said electro-optical switching elements.

48. A flexible display device according to claim 47, wherein said diffusing element comprises at least one layer of fabric.

49. A flexible display device according to claim 48, wherein said diffusing element comprises at least one layer of non-woven fabric.

50. A flexible display device according to claim 49, wherein the density of the non-woven fabric is lower at a face of the diffusing element facing an electro-optical switching element compared to the density at a face of the diffusing element opposite to said electro-optical switching element.

51. A flexible display device according to claim 47, further comprising an elastomer layer (28) disposed between said substrate and said diffusing element.

52. A flexible display device according to claim 36, wherein said substrate and electro-optical switching elements are encapsulated by an encapsulation.

53. A flexible display device according to claim 52, wherein said encapsulation comprises an elastomer material.

54. A flexible display device according to claim 36, further comprising an outermost layer comprising at least one cover layer of whitish fabric (30).

55. A flexible display device according to claim 54, wherein said outermost layer further comprises at least one cover layer of colored open structure fabric (32) on top of said whitish fabric cover layer(s).

56. A flexible display device according to claim 36, further comprising an outermost layer comprising at least one cover layer of colored open structure fabric (32).

57. A flexible display device according to claim 36, further comprising driver electronics (13) for driving the electro-optical switching elements, wherein said driver electronics are positioned separated from said flexible substrate.

58. A flexible display device according to claim 57, wherein said driver electronics are positioned on a rigid substrate (15) separated from said flexible substrate.

59. A method for the manufacture of a flexible display device, comprising:
providing a flexible substrate,
providing a plurality of electro-optical switching elements on said substrate, and
providing a plurality of through openings in said substrate, said openings being arranged in a repetitive pattern so that said electro-optical switching elements are located in areas of the substrate adjacent to said openings.

60. A method according to claim 59, wherein said through openings are achieved by punching by means of a punch (24).

61. A method according to claim 60, wherein said substrate comprises an upper and lower plastic sheet, the electro-optical switching elements being positioned between said sheets, and wherein said punch during a punching operation is heated to at least the melting temperature of said sheets, for creating a seal between said sheets at said openings.

62. A textile product comprising a flexible display device according to claim 36.

63. A textile product according to claim 62, further comprising communication means adapted to receive data, and means for controlling the output of the display device according to said received data.

64. A textile product according to claim 62, further comprising sensor means adapted to detect a condition related to said textile product, and means for controlling the output of the display device according to said detected condition.

65. A textile product according to claim 64, wherein said sensor means is one of: a compass, a pressure sensor, a positioning system, light detector and a temperature sensor.

66. A textile product according to claim 63, wherein said communication means is further adapted to transmit data based on input from an input means of said textile product.

67. A textile product according to claim 66, wherein said input means is constituted by said sensor means.

68. A textile product according to claim 62, wherein said textile product is one of: a pillow, a curtain, a furnishing fabric, a vehicle ceiling, a bed textile, a toy, a mat or carpet, a table cloth, a garment, a pouch, a bag, and a backpack.

69. A textile product according to claim 62, wherein said textile product is a bag or back pack further comprising an audio system and means for controlling the output of the display device according to a signal from said audio system.
